(19) United States
(12) Patent Application Publication
(10) Pub. No.: US 2026/0295799 A1
(43) Pub. Date: Oct. 1, 2026

(54) FOLDABLE TOOL WITH POSITIONING MECHANISM

(71) Applicant: Hong Ann Tool Industries Co., Ltd., Taichung City (TW)

(72) Inventor: Cheng-Wei SU, Taichung City (TW)

(21) Appl. No.: 19/354,237

(22) Filed: Oct. 9, 2025

(30) Foreign Application Priority Data
Mar. 28, 2025 (TW) 114112150

(51) Int. Cl. B25F 1/04

(52) U.S. Cl. CPC B25F 1/04

(57) ABSTRACT

A foldable tool includes a body, a tool head assembly, and a positioning mechanism. The tool head assembly has at least one first tool head provided with a first pivoting portion pivotally connected to the body about a first axis and at least one first engaging portion. The positioning mechanism includes a first fastening member having a first fastening portion and a first positioning button movable along a radial direction of the first axis between a locking position and a releasing position. When the first positioning button is in the locking position, the first fastening portion engages with the first engaging portion to restrict rotation of the first tool head. When the first positioning button is in the releasing position, the first fastening portion is disengaged to allow rotation.

### BACKGROUND OF THE INVENTION

The present invention relates to a foldable tool, and more particularly, to a foldable tool with a positioning mechanism.

Taiwan Utility Patent No. TWM537006 discloses a positioning folding tool, which includes a housing, a support plate, a plurality of tool portions, a fixing portion, and a positioning unit. The support plate is disposed in the housing. The tool portion includes a positioning member having a plurality of grooves and a tool member fixed to the positioning member. The fixing portion includes a fixing member and a locking member. The positioning unit includes an elastic member and a positioning plate. A first end of the positioning plate is pushed by the elastic member so that a second end of the positioning plate is maintained at a first position, in which the tool member and the support plate are fixed at a first angle. By pressing the first end of the positioning plate to compress the elastic member, the second end of the positioning plate is shifted to a second position, in which the tool member is movable relative to the support plate within a range of a second angle.

However, in the above conventional structure, the tool portion and the positioning plate are disposed on opposite sides of the tool. If the user presses the positioning plate first, the tool must then be turned over to view and rotate the tool portion. Conversely, if the tool portion is grasped first, the positioning plate must subsequently be pressed. Such an arrangement leads to inconvenient operation. In addition, the tool portion cannot be too long, since it would otherwise obstruct the positioning plate.

### SUMMARY OF THE INVENTION

An object of the invention is to provide a foldable tool comprising a body, a tool head assembly, and at least one positioning mechanism configured to selectively restrict or release rotation of one or more tool heads relative to the body. The tool head assembly includes at least one first tool head having a pivoting portion pivotally connected to the body about a first axis, and the pivoting portion is provided with at least one engaging portion on its outer periphery. The positioning mechanism includes a fastening member provided with a fastening portion and a positioning button that is movably connected to the body to move along a radial direction of the first axis between a locking position and a releasing position. In the locking position, the fastening portion engages with the engaging portion to restrict rotation of the tool head relative to the body, while in the releasing position, the fastening portion disengages from the engaging portion to permit rotation of the tool head.

The fastening member may be pivotally connected to the body with a pivot axis parallel to the first axis, and one end thereof is provided with a protrusion engaged by a guiding portion of the positioning button such that the protrusion slides along the guiding portion as the button moves. The body may include a middle seat formed as an integral structure, in which pivot holes receive a pin serving as the pivot axis of the fastening member. Side covers are connected to opposite sides of the middle seat, with sliding slots guiding flanges of the positioning button. An elastic member with a coiling portion sleeved on the pin provides a restoring force that biases the fastening member and the positioning button toward the locking position. The body may further include a first pivot shaft inserted through the middle seat, with locking members threadedly connected from opposite sides of the side covers to fix the shaft, and the first pivoting portion of the tool head sleeved on the pivot shaft. A limiting portion on the pivot shaft cooperates with a limiting hole of the middle seat to prevent undesired shaft rotation relative to the body.

The tool head assembly may further include at least one second tool head pivotally connected to the body about a second axis, wherein the second tool head is provided with engaging portions on its outer periphery. A second fastening member and a second positioning button cooperate in the same manner as the first positioning mechanism, with the fastening portion of the second fastening member engaging or disengaging the engaging portions of the second tool head to selectively restrict or release its rotation relative to the body. The second fastening member may be pivotally connected to the body with a pivot axis parallel to the second axis and may be provided with a protrusion engaged by a guiding portion of the second positioning button. A pin and pivot holes define the pivot axis, and a second elastic member with a coiling portion sleeved on the pin provides a restoring force that biases the second fastening member toward the locking position. The body further includes a second pivot shaft inserted into the middle seat along the second axis and secured by locking members, with the second pivoting portion of the tool head sleeved on the shaft. A limiting portion on the second pivot shaft is received in a non-circular limiting hole of the body to prevent rotation of the second pivot shaft relative to the body.

In another embodiment, the fastening member may be movably connected to the body in a sliding manner rather than pivotally. The fastening member may include two protrusions disposed on opposite ends thereof along the axis and engaged by two guiding portions of the positioning button, such that the protrusions slide along the guiding portions when the positioning button moves. Engaging protrusions on opposite ends of the fastening member may be inserted into engaging slots of the middle seat and slidably retained therein. A through hole is formed in the middle seat, and an elastic member provided with inserting portions and an abutting portion cooperates with the fastening member, such that the abutting portion passes through the through hole and biases the fastening member toward the locking position. The same arrangement may be applied to the second positioning mechanism, wherein the second fastening member is slidably connected and provided with two protrusions engaged by corresponding guiding portions of the second positioning button, engaging protrusions slidable in engaging slots of the body, and a second elastic member provided with inserting portions and an abutting portion passing through a through hole of the middle seat. These structures provide equivalent selective engagement and restoring force as the pivotally connected fastening members.

The invention further provides that the first tool head and the second tool head may be disposed on opposite sides of the body, with their pivoting portions respectively connected to opposite ends of the body. Each tool head is provided with a working portion opposite to its pivoting portion. When folded, the working portion of each tool head is adjacent to the pivoting portion of the opposite tool head, while in the unfolded state, each working portion extends away from the pivoting portion of the opposite tool head. The distance from the fastening members to the pivot shafts and from the working portions to the pivot shafts defines lengths, such that the working portions extend beyond the fastening members to provide effective leverage, wherein the second length defined by the working portion is greater than the first length defined by the fastening member.

Each engaging portion may include a plurality of engaging portions, allowing the fastening portion to selectively engage different positions such that the tool head can be fixed in a folded position, a 90-degree unfolded position, or a 180-degree unfolded position. The tool heads may further include a plurality of flat outer peripheral surfaces extending tangentially along the pivot shafts and disposed between adjacent engaging portions, thereby defining stable angular positions. The tool head assembly may include multiple first tool heads and multiple second tool heads, each pivotally connected to the respective pivot shaft and arranged side by side along the axis, thereby enabling multiple tool heads to be folded and locked independently or simultaneously.

By the above configurations, the foldable tool achieves reliable positioning of one or more tool heads on both sides of the body, provides stable folded, partially unfolded, and fully unfolded states, prevents undesired shaft rotation, ensures safe operation, and allows versatile use in different applications across both embodiments.

The present invention will become clearer in light of the following detailed description of illustrative embodiments of this invention described in connection with the drawings.

### BRIEF DESCRIPTION OF DRAWINGS

FIG. 1 is a perspective view of a first embodiment of a foldable tool with a positioning mechanism according to the present invention.

FIG. 2 is an exploded perspective view of the foldable tool of FIG. 1.

FIG. 3 is another exploded perspective view of the foldable tool of FIG. 1 from a different angle.

FIG. 4 is a cross-sectional view of the foldable tool of FIG. 1.

FIG. 5 is another cross-sectional view of the foldable tool of FIG. 1 from a different angle.

FIG. 6 is a cross-sectional view of the foldable tool, showing the tool heads in a 45-degree unfolded state.

FIG. 7 is a cross-sectional view of the foldable tool, showing the tool heads in a 90-degree unfolded state.

FIG. 8 is an exploded perspective view of a second embodiment of a foldable tool with a positioning mechanism according to the present invention.

FIG. 9 is another exploded perspective view of the foldable tool of FIG. 8 from a different angle.

FIG. 10 is a cross-sectional view of the foldable tool of FIG. 8.

FIG. 11 is another cross-sectional view of the foldable tool of FIG. 8 from a different angle.

### DETAILED DESCRIPTION OF THE INVENTION

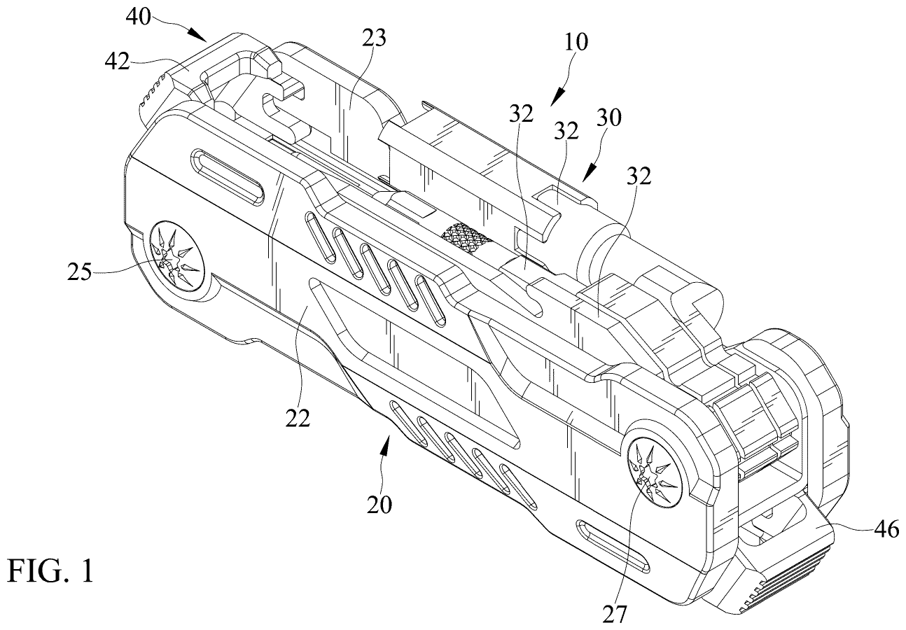

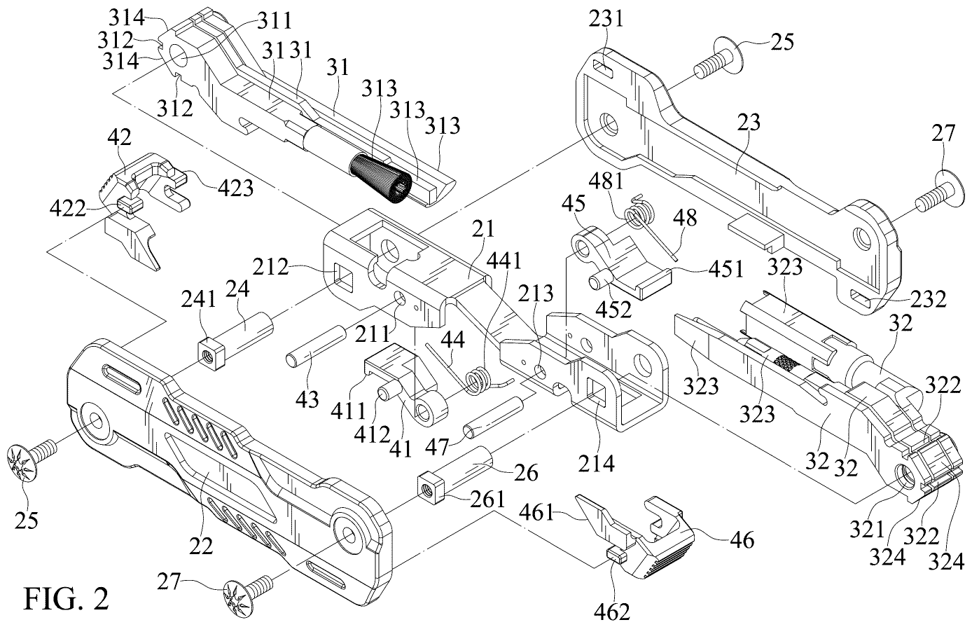

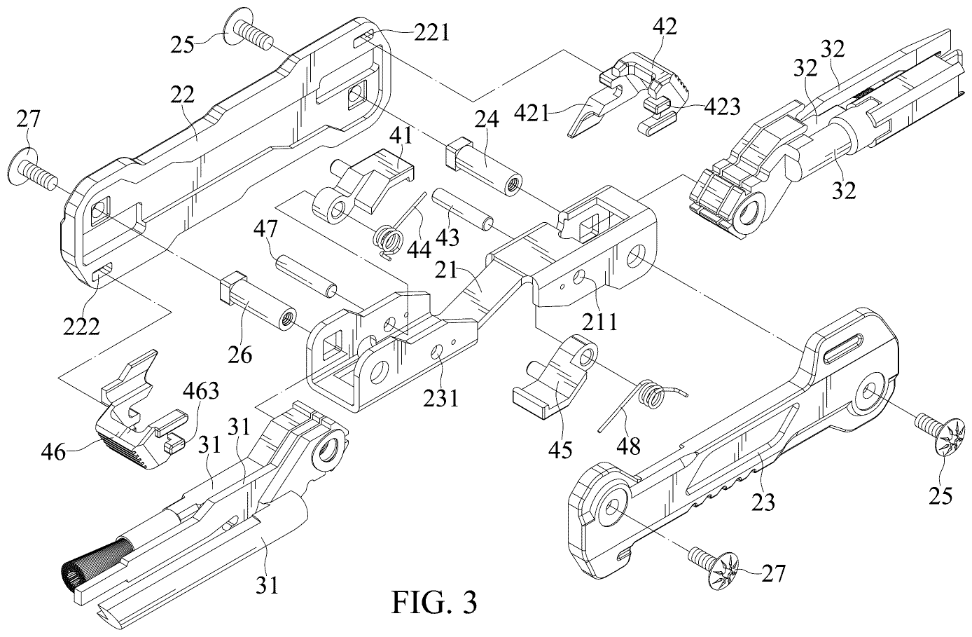

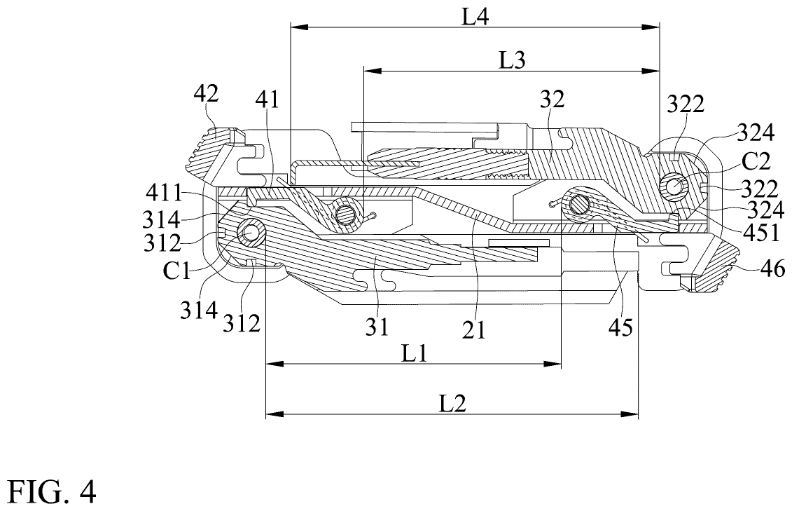

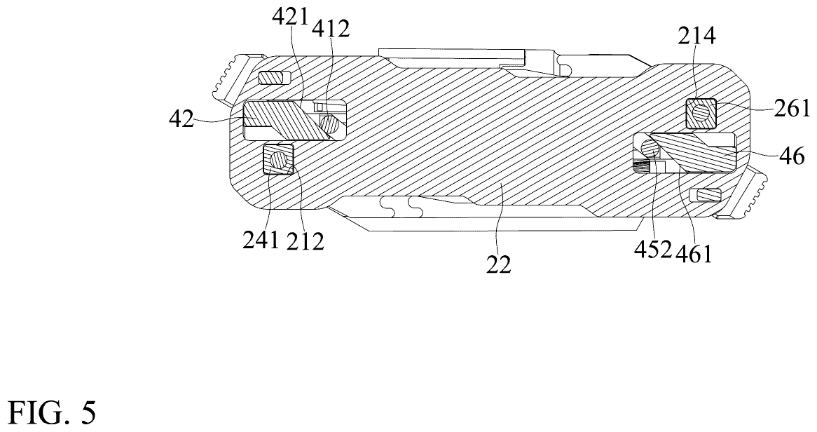

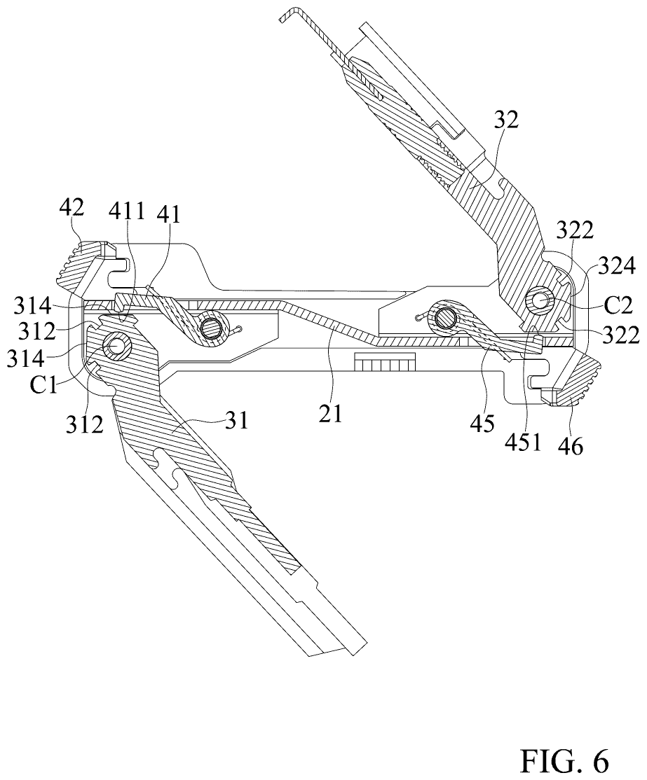

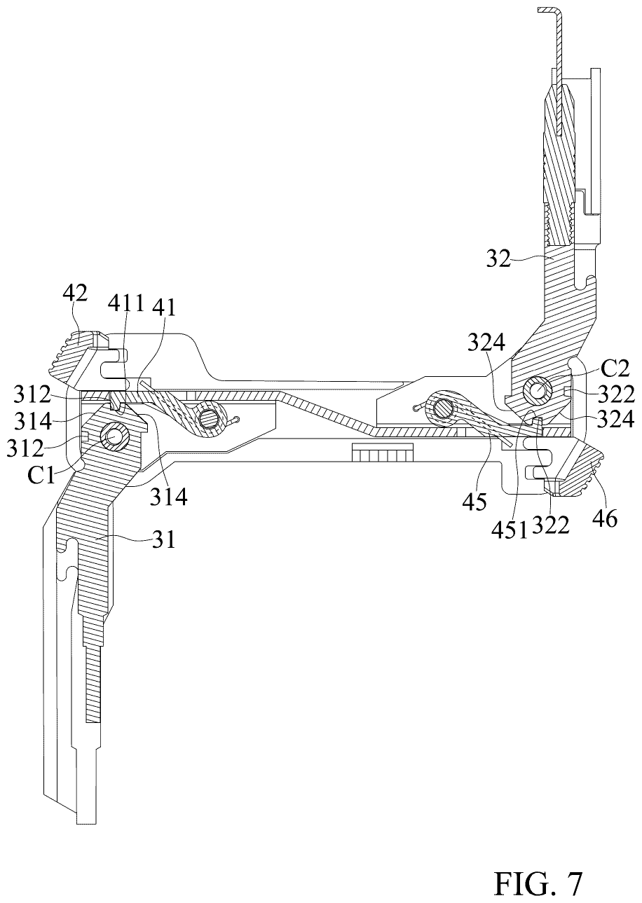

FIGS. 1-7 illustrate a foldable tool 10 of a first embodiment according to the present invention. The foldable tool 10 includes a body 20, a tool head assembly 30, and the positioning mechanism 40.

The tool head assembly 30 includes at least one first tool head 31. One end of the at least one first tool head 31 is provided with a first pivoting portion 311 pivotally connected to the body 20 about a first axis C1, and at least one first engaging portion 312 disposed on an outer periphery of the first pivoting portion 311.

The positioning mechanism 40 includes a first fastening member 41 and a first positioning button 42. The first fastening member 41 is movably disposed in the body 20 and provided with a first fastening portion 411. The first positioning button 42 is movably connected to the body 20 to move along a radial direction of the first axis C1 between a first locking position and a first releasing position.

When the first positioning button 42 is in the first locking position, the first positioning button 42 does not push the first fastening member 41 to move, such that the first fastening portion 411 engages with the at least one first engaging portion 312 to restrict rotation of the at least one first tool head 31 relative to the body 20.

When the first positioning button 42 is in the first releasing position, the first positioning button 42 pushes the first fastening member 41 to move, such that the first fastening portion 411 is disengaged from the at least one first engaging portion 312 to release the restriction of rotation of the at least one first tool head 31 relative to the body 20.

The first fastening member 41 is pivotally connected to the body 20. A pivot axis of the first fastening member 41 is parallel to the first axis C1.

One end of the first fastening member 41 along the first axis C1 is provided with a first protrusion 412 on an outer periphery thereof. The first positioning button 42 is provided with a first guiding portion 421 in constant contact with the first protrusion 412, such that when the first positioning button 42 moves between the first locking position and the first releasing position, the first protrusion 412 slides along a surface of the first guiding portion 421.

The body 20 includes a middle seat 21 formed as an integral structure. The middle seat 21 is provided with two first pivot holes 211 respectively disposed on two opposite sides along the first axis C1. The positioning mechanism 40 further includes a first pin 43. Two ends of the first pin 43 are respectively inserted into the two first pivot holes 211. The first fastening member 41 is disposed in the middle seat 21 and rotatably sleeved on the first pin 43 about the first pin 43.

The body 20 further includes a first side cover 22 and a second side cover 23 respectively connected to the two opposite sides of the middle seat 21 along the first axis C1. One side of the first side cover 22 adjacent to the second side cover 23 is provided with a first sliding slot 221. One side of the second side cover 23 adjacent to the first side cover 22 is provided with a second sliding slot 231. The first positioning button 42 is provided with a first flange 422 and a second flange 423 respectively formed on two opposite sides thereof along the first axis C1. The first flange 422 is slidably disposed in the first sliding slot 221. The second flange 423 is slidably disposed in the second sliding slot 231.

The positioning mechanism 40 further includes a first elastic member 44 provided with a first coiling portion 441 disposed between two ends thereof. The first coiling portion 441 is coiled for at least one turn and sleeved on the first pin 43. One end of the first elastic member 44 is inserted into the middle seat 21 and another end of the first elastic member 44 abuts against one side of the first fastening member 41 opposite to the first pivoting portion 311.

When the first positioning button 42 is in the first releasing position, the first fastening member 41 pushes the first elastic member 44 to be twisted and deformed, and the first elastic member 44 provides a restoring force to bias the first fastening member 41 to push the first positioning button 42 toward the first locking position.

The body 20 further includes a first pivot shaft 24 and two first locking members 25. The first pivot shaft 24 is inserted into the middle seat 21 along the first axis C1. The two first locking members 25 respectively extend through the first side cover 22 and the second side cover 23 from sides opposite to the middle seat 21 and are threadedly connected to the first pivot shaft 24. The first pivoting portion 311 is sleeved on the first pivot shaft 24.

One side of the middle seat 21 adjacent to the first side cover 22 is provided with a first limiting hole 212 having a non-circular shape. One end of the first pivot shaft 24 adjacent to the first side cover 22 is provided with a first limiting portion 241 disposed on an outer periphery thereof along a radial direction of the first pivot shaft 24 and having a shape corresponding to the first limiting hole 212. The first limiting portion 241 is inserted into the first limiting hole 212 to prevent the first pivot shaft 24 from rotating relative to the middle seat 21.

The tool head assembly 30 further includes at least one second tool head 32. One end of the at least one second tool head 32 is provided with a second pivoting portion 321 pivotally connected to the body 20 about a second axis C2, and at least one second engaging portion 322 disposed on an outer periphery of the at least one second tool head 32.

The positioning mechanism 40 further includes a second fastening member 45 and a second positioning button 46. The second fastening member 45 is pivotally connected to the body 20 with a pivot axis parallel to the second axis C2. The second fastening member 45 is provided with a second fastening portion 451. The second positioning button 46 is movably connected to the body 20 to move along a radial direction of the second axis C2 between a second locking position and a second releasing position.

When the second positioning button 46 is in the second locking position, the second positioning button 46 does not push the second fastening member 45 to move, such that the second fastening portion 451 engages with the at least one second engaging portion 322 to restrict rotation of the at least one second tool head 32 relative to the body 20.

When the second positioning button 46 is in the second releasing position, the second positioning button 46 pushes the second fastening member 45 to move, such that the second fastening portion 451 is disengaged from the at least one second engaging portion 322 to release the restriction of rotation of the at least one second tool head 32 relative to the body 20.

One end of the second fastening member 45 along the second axis C2 is provided with a second protrusion 452 on an outer periphery thereof. The second positioning button 46 is provided with a second guiding portion 461 in constant contact with the second protrusion 452, such that when the second positioning button 46 moves between the second locking position and the second releasing position, the second protrusion 452 slides along a surface of the second guiding portion 461.

The middle seat 21 is provided with two second pivot holes 213 respectively disposed on two opposite sides along the second axis C2. The positioning mechanism 40 further includes a second pin 47. Two ends of the second pin 47 are respectively inserted into the two second pivot holes 213. The second fastening member 45 is disposed in the middle seat 21 and rotatably sleeved on the second pin 47 about the second pin 47.

One side of the first side cover 22 adjacent to the second side cover 23 is provided with a third sliding slot 222. One side of the second side cover 23 adjacent to the first side cover 22 is provided with a fourth sliding slot 232. The second positioning button 46 is provided with a third flange 462 and a fourth flange 463 respectively formed on two opposite sides thereof along the second axis C2. The third flange 462 is slidably disposed in the third sliding slot 222. The fourth flange 463 is slidably disposed in the fourth sliding slot 232.

The positioning mechanism 40 further includes a second elastic member 48 provided with a second coiling portion 481 disposed between two ends thereof. The second coiling portion 481 is coiled for at least one turn and sleeved on the second pin 47. One end of the second elastic member 48 is inserted into the middle seat 21 and another end of the second elastic member 48 abuts against one side of the second fastening member 45 opposite to the second pivoting portion 321.

When the second positioning button 46 is in the second releasing position, the second fastening member 45 pushes the second elastic member 48 to be twisted and deformed, and the second elastic member 48 provides a restoring force to bias second fastening member 45 to push the second positioning button 46 toward the second locking position.

The body 20 further includes a second pivot shaft 26 and two second locking members 27. The second pivot shaft 26 is inserted into the middle seat 21 along the second axis C2. The two second locking members 27 respectively extend through the first side cover 22 and the second side cover 23 from sides opposite to the middle seat 21 and are threadedly connected to the second pivot shaft 26. The second pivoting portion 321 is sleeved on the second pivot shaft 26.

One side of the middle seat 21 adjacent to the first side cover 22 is provided with a second limiting hole 214 having a non-circular shape. One end of the second pivot shaft 26 adjacent to the first side cover 22 is provided with a second limiting portion 261 disposed on an outer periphery thereof along a radial direction of the second pivot shaft 26 and having a shape corresponding to the second limiting hole 214. The second limiting portion 261 is inserted into the second limiting hole 214 to prevent the second pivot shaft 26 from rotating relative to the middle seat 21.

The at least one first tool head 31 and the at least one second tool head 32 are respectively disposed on two opposite sides of the body 20. The first pivoting portion 311 and the second pivoting portion 321 are respectively pivotally connected to two opposite ends of the body 20. The at least one first tool head 31 is provided with a first working portion 313 on one end opposite to the first pivoting portion 311. The at least one second tool head 32 is provided with a second working portion 323 on one end opposite to the second pivoting portion 321.

When the at least one first tool head 31 and the at least one second tool head 32 are folded, the first working portion 313 is adjacent to the second pivoting portion 321 and the second working portion 323 is adjacent to the first pivoting portion 311.

When the at least one first tool head 31 and the at least one second tool head 32 are unfolded, the first working portion 313 extends away from the second pivoting portion 321, and the second working portion 323 extends away from the first pivoting portion 311.

A distance from the second fastening member 45 to the first pivot shaft 24 defines a first length L1. A distance from the first working portion 313 to the first pivot shaft 24 defines a second length L2 greater than the first length L1. A distance from the first fastening member 41 to the second pivot shaft 26 defines a third length L3. A distance from the second working portion 323 to the second pivot shaft 26 defines a fourth length L4 greater than the third length L3.

In the embodiment, the at least one first engaging portion 312 includes a plurality of first engaging portions 312. When the first positioning button 42 is in the first locking position, the first fastening portion 411 engages with one of the plurality of first engaging portions 312 such that the at least one first tool head 31 is fixed in a folded position, a 90-degree unfolded position, or a 180-degree unfolded position; and The at least one second engaging portion 322 includes a plurality of second engaging portions 322. When the second positioning button 46 is in the second locking position, the second fastening portion 451 engages with one of the plurality of second engaging portions 322 such that the at least one second tool head 32 is fixed in a folded position, a 90-degree unfolded position, or a 180-degree unfolded position.

The at least one first tool head 31 is provided with a plurality of first outer peripheral surfaces 314 disposed on an outer periphery thereof along a radial direction of the first pivot shaft 24. The plurality of first outer peripheral surfaces 314 are flat surfaces respectively extending in a tangential direction of the first pivot shaft 24. Each of the plurality of first outer peripheral surfaces 314 is disposed between two adjacent ones of the plurality of first engaging portions 312. The at least one second tool head 32 is provided with a plurality of second outer peripheral surfaces 324 disposed on an outer periphery thereof along a radial direction of the second pivot shaft 26. The plurality of second outer peripheral surfaces 324 are flat surfaces respectively extending in a tangential direction of the second pivot shaft 26. Each of the plurality of second outer peripheral surfaces 324 is disposed between two adjacent ones of the plurality of second engaging portions 322.

In the embodiment, the at least one first tool head 31 includes a plurality of first tool heads 31. The plurality of first tool heads 31 are respectively pivotally connected to the first pivot shaft 24 and arranged side by side along the first axis C1. The at least one second tool head 32 includes a plurality of second tool heads 32. The plurality of second tool heads 32 are respectively pivotally connected to the second pivot shaft 26 and arranged side by side along the second axis C2.

The foldable tool 10, through the above-described configuration, not only facilitates user operation but also provides a more efficient spatial arrangement. The first positioning button 42 and the second positioning button 46 can be respectively disposed at positions adjacent to two ends of the body 20. Regardless of whether the first tool head 31 or the second tool head 32 is unfolded, the user's fingers can easily reach the first positioning button 42 or the second positioning button 46, thereby providing a high degree of convenience. The operation of the first fastening member 41 and the second fastening member 45 does not interfere with the first working portion 313 or the second working portion 323, allowing the body 20 to be equipped with tool heads that are nearly equal in length to the body 20 itself, thereby improving space utilization.

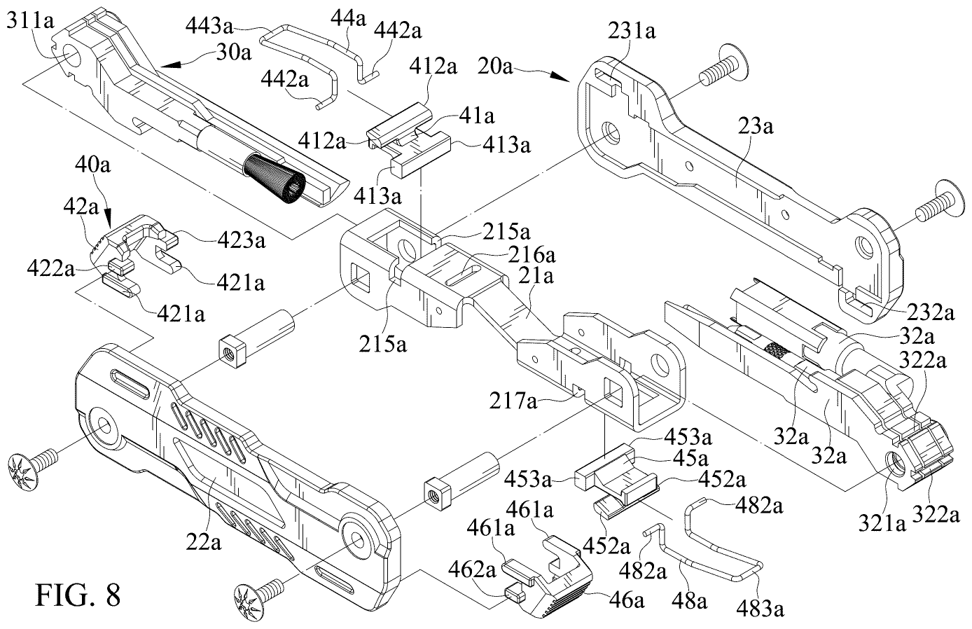

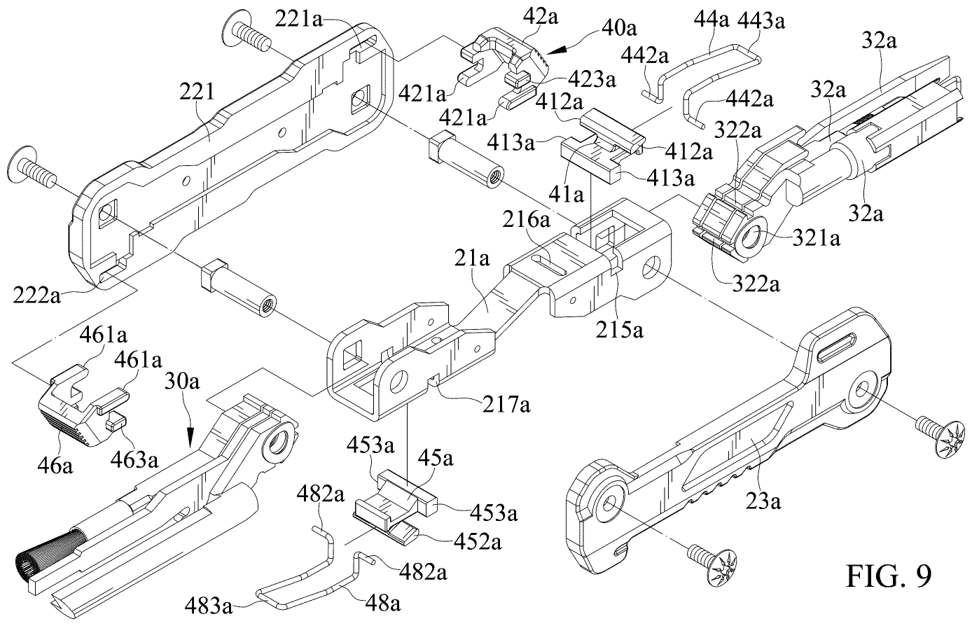

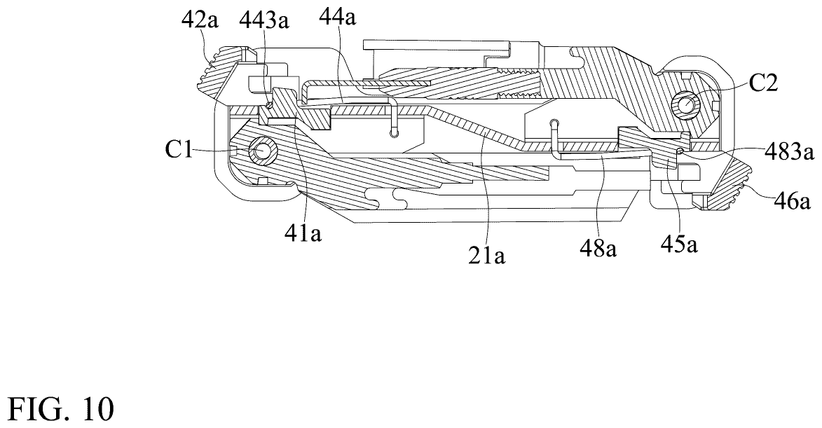

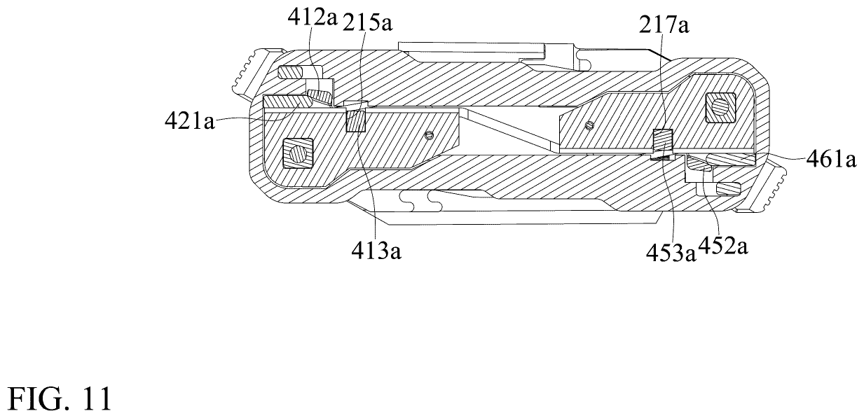

FIGS. 8-11 illustrate a foldable tool 10 of a second embodiment according to the present invention. The second embodiment is generally similar to the first embodiment, with the primary difference being that the first fastening member 41a is movably connected to the body 20a to move along the radial direction of the first axis C1.

The first fastening member 41a is provided with two first protrusions 412a respectively disposed on an outer periphery of two opposite ends thereof along the first axis C1. The first positioning button 42a is provided with two first guiding portions 421a in constant contact with the two first protrusions 412a, such that when the first positioning button 42a moves between the first locking position and the first releasing position, the two first protrusions 412a respectively slide along surfaces of the two first guiding portions 421a.

The body 20a includes a middle seat 21a formed as an integral structure. Two first engaging slots 215a are respectively provided on two opposite sides of the middle seat 21a along the first axis C1. The first fastening member 41a is provided with two first engaging protrusions 413a respectively disposed on two opposite ends thereof along the first axis C1. The two first engaging protrusions 413a are respectively inserted into the two first engaging slots 215a and are slidable therein.

The body 20a further includes a first side cover 22a and a second side cover 23a respectively connected to two opposite sides of the middle seat 21a along the first axis C1. One side of the first side cover 22a adjacent to the second side cover 23a is provided with a first sliding slot 221a. One side of the second side cover 23a adjacent to the first side cover 22a is provided with a second sliding slot 231a. The first positioning button 42a is provided with a first flange 422a and a second flange 423a respectively disposed on two opposite sides thereof along the first axis C1. The first flange 422a is slidably disposed in the first sliding slot 221a. The second flange 423a is slidably disposed in the second sliding slot 231a.

The middle seat 21a is provided with a first through hole 216a penetrating therethrough and communicating an inner periphery and an outer periphery thereof. The positioning mechanism 40a further includes a first elastic member 44a having two ends respectively provided with a first inserting portion 442a inserted into the inner periphery of the middle seat 21a. The first elastic member 44a further includes a first abutting portion 443a disposed between the two ends thereof. The first abutting portion 443a passes through the first through hole 216a and abuts against one side of the first fastening member 41a opposite to the first pivoting portion 311a.

When the first positioning button 42a is in the first releasing position, the first fastening member 41a pushes the first elastic member 44a to be twisted and deformed, and the first elastic member 44a provides a restoring force to bias the first fastening member 41a to push the first positioning button 42a toward the first locking position.

The tool head assembly 30a further includes at least one second tool head 32a. One end of the at least one second tool head 32a is provided with a second pivoting portion 321a pivotally connected to the body 20a about a second axis C2, and at least one second engaging portion 322a disposed on an outer periphery of the at least one second tool head 32a.

The positioning mechanism 40a further includes a second fastening member 45a and a second positioning button 46a. The second fastening member 45a is movably connected to the body 20a to move along a radial direction of the second axis C2. The second fastening member 45a is provided with a second fastening portion 451a. The second positioning button 46a is movably connected to the body 20a to move along the radial direction of the second axis C2 between a second locking position and a second releasing position.

When the second positioning button 46a is in the second locking position, the second positioning button 46a does not push the second fastening member 45a to move, such that the second fastening portion 451a engages with the at least one second engaging portion 322a to restrict rotation of the at least one second tool head 32a relative to the body 20a.

When the second positioning button 46a is in the second releasing position, the second positioning button 46a pushes the second fastening member 45a to move, such that the second fastening portion 451a is disengaged from the at least one second engaging portion 322a to release the restriction of rotation of the at least one second tool head 32a relative to the body 20a.

The second fastening member 45a is provided with two second protrusions 452a respectively disposed on two opposite ends thereof along the second axis C2. The second positioning button 46a is provided with two second guiding portions 461a in constant contact with the two second protrusions 452a, such that when the second positioning button 46a moves between the second locking position and the second releasing position, the two second protrusions 452a respectively slide along surfaces of the two second guiding portions 461a.

The body 20a includes a middle seat 21a formed as an integral structure. Two second engaging slots 217a are respectively provided on two opposite sides of the middle seat 21a along the second axis C2. The second fastening member 45a is provided with two second engaging protrusions 453a respectively disposed on two opposite ends thereof along the second axis C2. The two second engaging protrusions 453a are respectively inserted into the two second engaging slots 217a and are slidable therein.

One side of the first side cover 22a adjacent to the second side cover 23a is provided with a third sliding slot 222a. One side of the second side cover 23a adjacent to the first side cover 22a is provided with a fourth sliding slot 232a. The second positioning button 46a is provided with a third flange 462a and a fourth flange 463a respectively disposed on two opposite sides thereof along the second axis C2. The third flange 462a is slidably disposed in the third sliding slot 222a. The fourth flange 463a is slidably disposed in the fourth sliding slot 232a.

The middle seat 21a is provided with a second through hole 218a penetrating therethrough and communicating an inner periphery and an outer periphery thereof. The positioning mechanism 40a further includes a second elastic member 48a having two ends respectively provided with a second inserting portion 482a inserted into the inner periphery of the middle seat 21a. The second elastic member 48a further includes a second abutting portion 483a disposed between the two ends thereof. The second abutting portion 483a passes through the second through hole 218a and abuts against one side of the second fastening member 45a opposite to the second pivoting portion 321a.

When the second positioning button 46a is in the second releasing position, the second fastening member 45a pushes the second elastic member 48a to be twisted and deformed, and the second elastic member 48a provides a restoring force to bias the second fastening member 45a to push the second positioning button 46a toward the second locking position.

From the above description, the present invention can be summarized to have the following advantages:

The foldable tool 10 with a positioning mechanism of the present invention comprises a body 20, a tool head assembly 30, and a positioning mechanism 40. The tool head assembly 30 includes at least one first tool head 31, one end of the first tool head 31 being provided with a first pivoting portion 311 pivotally connected to the body 20 about a virtual first axis C1. At least one first engaging portion 312 is disposed on an outer periphery of the first pivoting portion 311 of the first tool head 31. The positioning mechanism 40 includes a first fastening member 41 and a first positioning button 42, the first fastening member 41 being movably disposed on the body 20 and provided with a first fastening portion 411. The first positioning button 42 is movably connected to the body 20 to move along a radial direction of the first axis C1 between a first locking position and a first releasing position. When the first positioning button 42 is in the first locking position, the first positioning button 42 does not push the first fastening member 41 to move, such that the first fastening portion 411 engages with the first engaging portion 312 to restrict rotation of the first tool head 31 relative to the body 20. When the first positioning button 42 is in the first releasing position, the first positioning button 42 pushes the first fastening member 41 to move, such that the first fastening portion 411 disengages from the first engaging portion 312 to release the restriction on the rotation of the first tool head 31 relative to the body 20. Through the above configuration, the foldable tool 10 facilitates convenient operation for the user and provides a more efficient spatial arrangement.

Although specific embodiments have been illustrated and described, numerous modifications and variations are still possible without departing from the scope of the invention. The scope of the invention is limited by the accompanying claims.

1. A foldable tool, comprising:
a body;
a tool head assembly including at least one first tool head, wherein one end of the at least one first tool head is provided with a first pivoting portion pivotally connected to the body about a first axis, and at least one first engaging portion disposed on an outer periphery of the first pivoting portion; and
a positioning mechanism including a first fastening member and a first positioning button, wherein the first fastening member is movably disposed in the body and provided with a first fastening portion, and wherein the first positioning button is movably connected to the body to move along a radial direction of the first axis between a first locking position and a first releasing position;
wherein when the first positioning button is in the first locking position, the first positioning button does not push the first fastening member to move, such that the first fastening portion engages with the at least one first engaging portion to restrict rotation of the at least one first tool head relative to the body;
wherein when the first positioning button is in the first releasing position, the first positioning button pushes the first fastening member to move, such that the first fastening portion is disengaged from the at least one first engaging portion to release the restriction of rotation of the at least one first tool head relative to the body.

2. The foldable tool of claim 1, wherein the first fastening member is pivotally connected to the body, and wherein a pivot axis of the first fastening member is parallel to the first axis, wherein one end of the first fastening member along the first axis is provided with a first protrusion on an outer periphery thereof, and wherein the first positioning button is provided with a first guiding portion in constant contact with the first protrusion, such that when the first positioning button moves between the first locking position and the first releasing position, the first protrusion slides along a surface of the first guiding portion, wherein the body includes a middle seat formed as an integral structure, wherein the middle seat is provided with two first pivot holes respectively disposed on two opposite sides along the first axis, wherein the positioning mechanism further includes a first pin, wherein two ends of the first pin are respectively inserted into the two first pivot holes, and wherein the first fastening member is disposed in the middle seat and rotatably sleeved on the first pin about the first pin.

3. The foldable tool of claim 2, wherein the body further includes a first side cover and a second side cover respectively connected to the two opposite sides of the middle seat along the first axis, wherein one side of the first side cover adjacent to the second side cover is provided with a first sliding slot, wherein one side of the second side cover adjacent to the first side cover is provided with a second sliding slot, wherein the first positioning button is provided with a first flange and a second flange respectively formed on two opposite sides thereof along the first axis, wherein the first flange is slidably disposed in the first sliding slot, and wherein the second flange is slidably disposed in the second sliding slot, wherein the positioning mechanism further includes a first elastic member provided with a first coiling portion disposed between two ends thereof, wherein the first coiling portion is coiled for at least one turn and sleeved on the first pin, and wherein one end of the first elastic member is inserted into the middle seat and another end of the first elastic member abuts against one side of the first fastening member opposite to the first pivoting portion;
wherein when the first positioning button is in the first releasing position, the first fastening member pushes the first elastic member to be twisted and deformed, and the first elastic member provides a restoring force to bias the first fastening member to push the first positioning button toward the first locking position.

4. The foldable tool of claim 3, wherein the body further includes a first pivot shaft and two first locking members, wherein the first pivot shaft is inserted into the middle seat along the first axis, wherein the two first locking members respectively extend through the first side cover and the second side cover from sides opposite to the middle seat and are threadedly connected to the first pivot shaft, and wherein the first pivoting portion is sleeved on the first pivot shaft, wherein one side of the middle seat adjacent to the first side cover is provided with a first limiting hole having a non-circular shape, wherein one end of the first pivot shaft adjacent to the first side cover is provided with a first limiting portion disposed on an outer periphery thereof along a radial direction of the first pivot shaft and having a shape corresponding to the first limiting hole, and wherein the first limiting portion is inserted into the first limiting hole to prevent the first pivot shaft from rotating relative to the middle seat.

5. The foldable tool of claim 4, wherein the tool head assembly further includes at least one second tool head, and wherein one end of the at least one second tool head is provided with a second pivoting portion pivotally connected to the body about a second axis, and at least one second engaging portion disposed on an outer periphery of the at least one second tool head;
wherein the positioning mechanism further includes a second fastening member and a second positioning button, wherein the second fastening member is pivotally connected to the body with a pivot axis parallel to the second axis, wherein the second fastening member is provided with a second fastening portion, and wherein the second positioning button is movably connected to the body to move along a radial direction of the second axis between a second locking position and a second releasing position;
wherein when the second positioning button is in the second locking position, the second positioning button does not push the second fastening member to move, such that the second fastening portion engages with the at least one second engaging portion to restrict rotation of the at least one second tool head relative to the body;
wherein when the second positioning button is in the second releasing position, the second positioning button pushes the second fastening member to move, such that the second fastening portion is disengaged from the at least one second engaging portion to release the restriction of rotation of the at least one second tool head relative to the body;
wherein one end of the second fastening member along the second axis is provided with a second protrusion on an outer periphery thereof, wherein the second positioning button is provided with a second guiding portion in constant contact with the second protrusion, such that when the second positioning button moves between the second locking position and the second releasing position, the second protrusion slides along a surface of the second guiding portion;
wherein the middle seat is provided with two second pivot holes respectively disposed on two opposite sides along the second axis, wherein the positioning mechanism further includes a second pin, wherein two ends of the second pin are respectively inserted into the two second pivot holes, and wherein the second fastening member is disposed in the middle seat and rotatably sleeved on the second pin about the second pin;
wherein one side of the first side cover adjacent to the second side cover is provided with a third sliding slot, wherein one side of the second side cover adjacent to the first side cover is provided with a fourth sliding slot, wherein the second positioning button is provided with a third flange and a fourth flange respectively formed on two opposite sides thereof along the second axis, wherein the third flange is slidably disposed in the third sliding slot, and wherein the fourth flange is slidably disposed in the fourth sliding slot;
wherein the positioning mechanism further includes a second elastic member provided with a second coiling portion disposed between two ends thereof, wherein the second coiling portion is coiled for at least one turn and sleeved on the second pin, and wherein one end of the second elastic member is inserted into the middle seat and another end of the second elastic member abuts against one side of the second fastening member opposite to the second pivoting portion;
wherein when the second positioning button is in the second releasing position, the second fastening member pushes the second elastic member to be twisted and deformed, and the second elastic member provides a restoring force to bias second fastening member to push the second positioning button toward the second locking position;
wherein the body further includes a second pivot shaft and two second locking members, wherein the second pivot shaft is inserted into the middle seat along the second axis, wherein the two second locking members respectively extend through the first side cover and the second side cover from sides opposite to the middle seat and are threadedly connected to the second pivot shaft, and wherein the second pivoting portion is sleeved on the second pivot shaft;
wherein one side of the middle seat adjacent to the first side cover is provided with a second limiting hole having a non-circular shape, wherein one end of the second pivot shaft adjacent to the first side cover is provided with a second limiting portion disposed on an outer periphery thereof along a radial direction of the second pivot shaft and having a shape corresponding to the second limiting hole, and wherein the second limiting portion is inserted into the second limiting hole to prevent the second pivot shaft from rotating relative to the middle seat.

6. The foldable tool of claim 1, wherein the first fastening member is movably connected to the body to move along the radial direction of the first axis, wherein the first fastening member is provided with two first protrusions respectively disposed on an outer periphery of two opposite ends thereof along the first axis, and wherein the first positioning button is provided with two first guiding portions in constant contact with the two first protrusions, such that when the first positioning button moves between the first locking position and the first releasing position, the two first protrusions respectively slide along surfaces of the two first guiding portions, wherein the body includes a middle seat formed as an integral structure, wherein two first engaging slots are respectively provided on two opposite sides of the middle seat along the first axis, wherein the first fastening member is provided with two first engaging protrusions respectively disposed on two opposite ends thereof along the first axis, and wherein the two first engaging protrusions are respectively inserted into the two first engaging slots and are slidable therein.

7. The foldable tool of claim 6, wherein the body further includes a first side cover and a second side cover respectively connected to two opposite sides of the middle seat along the first axis, wherein one side of the first side cover adjacent to the second side cover is provided with a first sliding slot, wherein one side of the second side cover adjacent to the first side cover is provided with a second sliding slot, wherein the first positioning button is provided with a first flange and a second flange respectively disposed on two opposite sides thereof along the first axis, wherein the first flange is slidably disposed in the first sliding slot, and wherein the second flange is slidably disposed in the second sliding slot, wherein the middle seat is provided with a first through hole penetrating therethrough and communicating an inner periphery and an outer periphery thereof, wherein the positioning mechanism further includes a first elastic member having two ends respectively provided with a first inserting portion inserted into the inner periphery of the middle seat, wherein the first elastic member further includes a first abutting portion disposed between the two ends thereof, and wherein the first abutting portion passes through the first through hole and abuts against one side of the first fastening member opposite to the first pivoting portion;
wherein when the first positioning button is in the first releasing position, the first fastening member pushes the first elastic member to be twisted and deformed, and the first elastic member provides a restoring force to bias the first fastening member to push the first positioning button toward the first locking position.

8. The foldable tool of claim 7, wherein the body further includes a first pivot shaft and two first locking members, wherein the first pivot shaft is inserted into the middle seat along the first axis, wherein the two first locking members respectively extend through the first side cover and the second side cover from sides opposite to the middle seat and are threadedly connected to the first pivot shaft, and wherein the first pivoting portion is sleeved on the first pivot shaft, wherein one side of the middle seat adjacent to the first side cover is provided with a first limiting hole having a non-circular shape, wherein one end of the first pivot shaft adjacent to the first side cover is provided with a first limiting portion disposed on an outer periphery thereof along a radial direction of the first pivot shaft and having a shape corresponding to the first limiting hole, and wherein the first limiting portion is inserted into the first limiting hole to prevent the first pivot shaft from rotating relative to the middle seat.

9. The foldable tool of claim 8, wherein the tool head assembly further includes at least one second tool head, and wherein one end of the at least one second tool head is provided with a second pivoting portion pivotally connected to the body about a second axis, and at least one second engaging portion disposed on an outer periphery of the at least one second tool head;
wherein the positioning mechanism further includes a second fastening member and a second positioning button, wherein the second fastening member is movably connected to the body to move along a radial direction of the second axis, wherein the second fastening member is provided with a second fastening portion, and wherein the second positioning button is movably connected to the body to move along the radial direction of the second axis between a second locking position and a second releasing position;
wherein when the second positioning button is in the second locking position, the second positioning button does not push the second fastening member to move, such that the second fastening portion engages with the at least one second engaging portion to restrict rotation of the at least one second tool head relative to the body;
wherein when the second positioning button is in the second releasing position, the second positioning button pushes the second fastening member to move, such that the second fastening portion is disengaged from the at least one second engaging portion to release the restriction of rotation of the at least one second tool head relative to the body;
wherein the second fastening member is provided with two second protrusions respectively disposed on two opposite ends thereof along the second axis, and wherein the second positioning button is provided with two second guiding portions in constant contact with the two second protrusions, such that when the second positioning button moves between the second locking position and the second releasing position, the two second protrusions respectively slide along surfaces of the two second guiding portions;
wherein the body includes a middle seat formed as an integral structure, wherein two second engaging slots are respectively provided on two opposite sides of the middle seat along the second axis, wherein the second fastening member is provided with two second engaging protrusions respectively disposed on two opposite ends thereof along the second axis, and wherein the two second engaging protrusions are respectively inserted into the two second engaging slots and are slidable therein;
wherein one side of the first side cover adjacent to the second side cover is provided with a third sliding slot, wherein one side of the second side cover adjacent to the first side cover is provided with a fourth sliding slot, wherein the second positioning button is provided with a third flange and a fourth flange respectively disposed on two opposite sides thereof along the second axis, wherein the third flange is slidably disposed in the third sliding slot, and wherein the fourth flange is slidably disposed in the fourth sliding slot;
wherein the middle seat is provided with a second through hole penetrating therethrough and communicating an inner periphery and an outer periphery thereof, wherein the positioning mechanism further includes a second elastic member having two ends respectively provided with a second inserting portion inserted into the inner periphery of the middle seat, wherein the second elastic member further includes a second abutting portion disposed between the two ends thereof, and wherein the second abutting portion passes through the second through hole and abuts against one side of the second fastening member opposite to the second pivoting portion;
wherein when the second positioning button is in the second releasing position, the second fastening member pushes the second elastic member to be twisted and deformed, and the second elastic member provides a restoring force to bias the second fastening member to push the second positioning button toward the second locking position;
wherein the body further includes a second pivot shaft and two second locking members, wherein the second pivot shaft is inserted into the middle seat along the second axis, wherein the two second locking members respectively extend through the first side cover and the second side cover from sides opposite to the middle seat and are threadedly connected to the second pivot shaft, and wherein the second pivoting portion is sleeved on the second pivot shaft;
wherein one side of the middle seat adjacent to the first side cover is provided with a second limiting hole having a non-circular shape, wherein one end of the second pivot shaft adjacent to the first side cover is provided with a second limiting portion disposed on an outer periphery thereof along a radial direction of the second pivot shaft and having a shape corresponding to the second limiting hole, and wherein the second limiting portion is inserted into the second limiting hole to prevent the second pivot shaft from rotating relative to the middle seat.

10. The foldable tool of claim 5, wherein the at least one first tool head and the at least one second tool head are respectively disposed on two opposite sides of the body, wherein the first pivoting portion and the second pivoting portion are respectively pivotally connected to two opposite ends of the body, wherein the at least one first tool head is provided with a first working portion on one end opposite to the first pivoting portion, and wherein the at least one second tool head is provided with a second working portion on one end opposite to the second pivoting portion;
wherein when the at least one first tool head and the at least one second tool head are folded, the first working portion is adjacent to the second pivoting portion and the second working portion is adjacent to the first pivoting portion;
wherein when the at least one first tool head and the at least one second tool head are unfolded, the first working portion extends away from the second pivoting portion, and the second working portion extends away from the first pivoting portion.

11. The foldable tool of claim 10, wherein a distance from the second fastening member to the first pivot shaft defines a first length, wherein a distance from the first working portion to the first pivot shaft defines a second length greater than the first length, wherein a distance from the first fastening member to the second pivot shaft defines a third length, and wherein a distance from the second working portion to the second pivot shaft defines a fourth length greater than the third length.

12. The foldable tool of claim 5, wherein the at least one first engaging portion includes a plurality of first engaging portions, wherein when the first positioning button is in the first locking position, the first fastening portion engages with one of the plurality of first engaging portions such that the at least one first tool head is fixed in a folded position, a 90-degree unfolded position, or a 180-degree unfolded position; and wherein the at least one second engaging portion includes a plurality of second engaging portions, wherein when the second positioning button is in the second locking position, the second fastening portion engages with one of the plurality of second engaging portions such that the at least one second tool head is fixed in a folded position, a 90-degree unfolded position, or a 180-degree unfolded position.

13. The foldable tool of claim 12, wherein the at least one first tool head is provided with a plurality of first outer peripheral surfaces disposed on an outer periphery thereof along a radial direction of the first pivot shaft, wherein the plurality of first outer peripheral surfaces are flat surfaces respectively extending in a tangential direction of the first pivot shaft, wherein each of the plurality of first outer peripheral surfaces is disposed between two adjacent ones of the plurality of first engaging portions, wherein the at least one second tool head is provided with a plurality of second outer peripheral surfaces disposed on an outer periphery thereof along a radial direction of the second pivot shaft, wherein the plurality of second outer peripheral surfaces are flat surfaces respectively extending in a tangential direction of the second pivot shaft, and wherein each of the plurality of second outer peripheral surfaces is disposed between two adjacent ones of the plurality of second engaging portions.

14. The foldable tool of claim 5, wherein the at least one first tool head includes a plurality of first tool heads, wherein the plurality of first tool heads are respectively pivotally connected to the first pivot shaft and arranged side by side along the first axis, wherein the at least one second tool head includes a plurality of second tool heads, and wherein the plurality of second tool heads are respectively pivotally connected to the second pivot shaft and arranged side by side along the second axis.

15. The foldable tool of claim 9, wherein the at least one first tool head and the at least one second tool head are respectively disposed on two opposite sides of the body, wherein the first pivoting portion and the second pivoting portion are respectively pivotally connected to two opposite ends of the body, wherein the at least one first tool head is provided with a first working portion on one end opposite to the first pivoting portion, and wherein the at least one second tool head is provided with a second working portion on one end opposite to the second pivoting portion;
wherein when the at least one first tool head and the at least one second tool head are folded, the first working portion is adjacent to the second pivoting portion and the second working portion is adjacent to the first pivoting portion;
wherein when the at least one first tool head and the at least one second tool head are unfolded, the first working portion extends away from the second pivoting portion, and the second working portion extends away from the first pivoting portion.

16. The foldable tool of claim 15, wherein a distance from the second fastening member to the first pivot shaft defines a first length, wherein a distance from the first working portion to the first pivot shaft defines a second length greater than the first length, wherein a distance from the first fastening member to the second pivot shaft defines a third length, and wherein a distance from the second working portion to the second pivot shaft defines a fourth length greater than the third length.

17. The foldable tool of claim 9, wherein the at least one first engaging portion includes a plurality of first engaging portions, wherein when the first positioning button is in the first locking position, the first fastening portion engages with one of the plurality of first engaging portions such that the at least one first tool head is fixed in a folded position, a 90-degree unfolded position, or a 180-degree unfolded position; and wherein the at least one second engaging portion includes a plurality of second engaging portions, wherein when the second positioning button is in the second locking position, the second fastening portion engages with one of the plurality of second engaging portions such that the at least one second tool head is fixed in a folded position, a 90-degree unfolded position, or a 180-degree unfolded position.

18. The foldable tool of claim 17, wherein the at least one first tool head is provided with a plurality of first outer peripheral surfaces disposed on an outer periphery thereof along a radial direction of the first pivot shaft, wherein the plurality of first outer peripheral surfaces are flat surfaces respectively extending in a tangential direction of the first pivot shaft, wherein each of the plurality of first outer peripheral surfaces is disposed between two adjacent ones of the plurality of first engaging portions, wherein the at least one second tool head is provided with a plurality of second outer peripheral surfaces disposed on an outer periphery thereof along a radial direction of the second pivot shaft, wherein the plurality of second outer peripheral surfaces are flat surfaces respectively extending in a tangential direction of the second pivot shaft, and wherein each of the plurality of second outer peripheral surfaces is disposed between two adjacent ones of the plurality of second engaging portions.

19. The foldable tool of claim 9, wherein the at least one first tool head includes a plurality of first tool heads, wherein the plurality of first tool heads are respectively pivotally connected to the first pivot shaft and arranged side by side along the first axis, wherein the at least one second tool head includes a plurality of second tool heads, and wherein the plurality of second tool heads are respectively pivotally connected to the second pivot shaft and arranged side by side along the second axis.
